(19) United States
(12) Patent Application Publication
(10) Pub. No.: US 2010/0319454 A1
(43) Pub. Date: Dec. 23, 2010

(54) METHOD AND SYSTEM FOR DETERMINING YOUNG'S MODULUS AND POISSON'S RATIO FOR A CRYSTALLINE MATERIAL

(75) Inventor: George Roy, Manotick (CA)

Correspondence Address: CHALKER FLORES, LLP, 2711 LBJ FRWY, Suite 1036, DALLAS, TX, 75234, US

(73) Assignee: Her Majesty The Queen in Right of Canada as Represented by the Minister of Natural Resources, Ottawa (CA)

(21) Appl. No.: 12/488,210

(22) Filed: Jun. 19, 2009

(51) Int. Cl. G01N 29/07; G01N 23/20

(52) U.S. Cl. 73/597; 378/71

(57) ABSTRACT

There is disclosed a method and system for determining Young's modulus and Poisson's ratio for an electrically conductive crystalline material. In general, one or more surface acoustic waves are generated in the crystalline material and a velocity of the surface acoustic waves is recorded. One or more applied strains in the crystalline material are also recorded using X-ray diffraction. The Young's modulus and Poisson's ratio can be determined from the recorded velocity(ies) and applied strain(s).

### FIELD OF THE INVENTION

The present invention relates to the field of materials science and in particular to methods and systems for determining Young's modulus and Poisson's ratio for a crystalline material.

### BACKGROUND

Various methods have been developed to characterize materials in order to develop a better understanding of their properties and thereby better predict how such materials will behave or interact with other materials in different applications or under different conditions. For example, the mechanical properties and/or characteristics of a material, and the mechanical constants or parameters qualifying and/or quantifying such properties, can be quite relevant in understanding how a material, and a structure or object manufactured from this material, will react in different conditions.

One conventional method known in the art for assessing strain-related characteristics of a material involves the use of a piezoelectric gauge or the like, as discussed by J. Marx in the article entitled “Use of the Piezoelectric Gauge for Internal Friction Measurements” published in The Review of Scientific Instruments, Vol. 22, Number 1, pp. 503-509. The use of such equipment, however, is generally limited in applicability to certain sample shapes and sizes, and for instance, is generally inapplicable to small scale samples. Other solutions, as described by Nakasawa, Nihei and Myer in the article entitled “Resonance Inversion for Elastic Moduli of Anisotropic Rocks” published in the Berkeley Annual Report, Earth Sciences Division, 1999-2000, provide methods for the determination of Young's modulus in smaller scale samples via acoustic resonance spectroscopy which, however, come at generally prohibitive costs.

Other examples are also known in the art for sampling and characterizing an object, for example in assessing the object's elastic properties under stress. For example, U.S. Pat. No. 6,517,679 to Mustonen et al. teaches a method for determining elastic properties of a paper web in a papermaking process; U.S. Pat. No. 3,881,346 to Scheucher teaches a method of continuously measuring the yield point and/or modulus of elasticity of a continuously moving wire by subjecting it to a predetermined tensile strain; U.S. Pat. No. 4,756,195 to Melton et al. teaches an apparatus for measuring a modulus of elasticity through angular displacement of a specimen under an applied torque; whereas U.S. Pat. No. 4,719,802 to Adini and U.S. Pat. No. 6,635,077 to Rauch teach different methods for determining deformations such as changes in the linear dimensions of an object using an electrical resistance strain or extensometer gauge.

Other methods have also been developed using bulk acoustic wave measurements to extract material characteristics. For example, in U.S. Pat. No. 3,918,294 to Makino et al., resonant ultrasonic waves are used to measure an axial force applied to an object, whereas U.S. Pat. No. 5,127,268 to Kline teaches the use of acoustic waves to determine a fibre volume fraction and resin porosity of a composite material using known parameters such as the constituent material's elastic moduli, densities and layup sequence. Also, U.S. Pat. No. 4,899,588 to Titlow et al. teaches a method for determining Young's modulus in tubes by measuring the speed at which bulk stress waves (i.e. P or S waves) propagate therein as a function of known parameters for the material in question, whereas U.S. Pat. No. 5,115,673 to Kline et al. teaches a method for determining the elastic moduli of a composite material by subjecting the object to x-radiation for determining its density at a sufficient number of discrete measurement points to create an image of local material density variation, and propagating bulk ultrasonic waves through the material to determine transit times for each wave at points corresponding to the measurement points.

The above and other such examples, however, may have various drawbacks, such as, in some cases, being limited in applicability to certain types, shapes and/or sizes of materials, or again, not allowing for an accounting of various material artifacts such as residual stresses or mechanical deformations generated upon manufacture of the tested material. Furthermore, some known methods involve significant data acquisition and computation, and oftentimes prohibitive costs.

Therefore, there is a need for a new method and system of determining Young's modulus and Poisson's ratio that overcomes some of the drawbacks of known techniques, or at least provides a useful alternative.

This background information is provided to reveal information believed by the applicant to be of possible relevance to the invention. No admission is necessarily intended, nor should be construed, that any of the preceding information constitutes prior art against the invention.

### SUMMARY

An object of the invention is to provide a method and system for determining Young's modulus and Poisson's ratio for a crystalline material. In accordance with an aspect of the invention, there is provided a method for determining Young's modulus and Poisson's ratio comprising the steps of: generating one or more surface acoustic waves in the crystalline material and recording a velocity of the surface acoustic waves; recording an applied strain in the crystalline material using X-ray diffraction; and determining the Young's modulus and the Poisson's ratio of the crystalline material from the recorded velocity and applied strain.

In accordance with another aspect of the invention, there is provided a system for determining Young's modulus and Poisson's ratio for a crystalline material, the system comprising: a surface acoustic wave device for generating a surface acoustic wave in the crystalline material and recording a velocity of the surface acoustic wave; a loading mechanism for applying a load to the crystalline material; an X-ray diffractometer for recording an applied strain in the loaded crystalline material; and a computing device comprising one or more data storage devices for storing the recorded velocity and applied strain, and one or more processors operatively coupled to the one or more data storage devices for calculating the Young's modulus and the Poisson's ratio of the crystalline material from the recorded velocity and applied strain.

Other aims, objects, advantages and features of the invention will become more apparent upon reading of the following non-restrictive description of embodiments thereof, given by way of example only with reference to the accompanying drawings.

### BRIEF DESCRIPTION OF THE FIGURES

The above and further advantages of the invention may be better understood by referring to the following description in conjunction with the accompanying drawings, in which:

FIG. 1 is a diagrammatic representation of an x-ray diffractometer setup with blown-up section identifying interactivity between x-rays produced thereby with respect to the atomic planes of a crystalline material.

FIG. 2 is a schematic diagram of a device for generating one or more surface acoustic waves in a material, in accordance with an embodiment of the invention.

FIG. 3 is a diagrammatic representation of a surface acoustic wave device for generating and detecting propagation of one or more surface acoustic waves in a material, in accordance with an embodiment of the invention.

FIG. 4 is a schematic diagram of a system for determining Young's modulus and Poisson's ratio, in accordance with an embodiment of the invention.

FIG. 5 is a schematic diagram of a system for determining Young's modulus and Poisson's ratio while accounting for residual stress, in accordance with an embodiment of the invention.

FIG. 6 is a diagrammatic representation of a sample subjected to a two-dimensional load for determining Young's modulus and Poisson's ratio with respect to two or more axes of the sample, in accordance with an embodiment of the invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. Unless defined otherwise, all technical and scientific terms used herein have the same meaning as commonly understood by one of ordinary skill in the art to which this invention belongs.

A method and system for determining Young's modulus and Poisson's ratio for a crystalline material will now be described, in accordance with various embodiments of the invention. In general, the method and system involve performing a combination of strain and surface acoustic wave measurements in the crystalline material, and from these measurements, determining Young's modulus and Poisson's ratio. For example, while x-ray diffraction has been used for some time to assess the properties of crystalline materials, the novel combination of these techniques with the use of surface acoustic wave measurements provides an alternative approach to studying these characteristics, which, in some embodiments, can provide for one or more of greater accuracy and/or precision, increased sampling efficiency and/or speed, reduced data processing and/or computation times, reduced exposure to potentially harmful radiation, and/or other advantages that will be readily apparent to the person of ordinary skill in the art upon reading the following non-limiting description. Furthermore, the system and method provides for a determination of both Young's modulus and Poisson's ratio, which, using conventional methods, are not readily accessible when neither characteristic is previously known.

Furthermore, in some embodiments where residual stress in the crystalline material may affect surface acoustic wave measurements, additional x-ray diffraction measurements may be implemented to determine or at least approximate an amount of residual stress in the crystalline material, which can then be taken into account when processing surface acoustic wave measurements to thereby improve an accuracy and/or precision of such measurements in determining Young's modulus and Poisson's ratio. For example, in one embodiment, two or more strain measurements may be processed to assess residual stress in the crystalline material. In another embodiment, x-ray diffraction may be used at the extremity of the sample material, for example after electric discharge machining, to ascertain the amount of residual stress present in the surface of the crystalline material in which surface acoustic wave measurements are conducted, relative to the core of the crystalline material, for example, where residual stress may be of lesser significance or even negligible.

In addition, or alternatively, two or more loads can be applied simultaneously with respect to distinct sample axes (i.e. a multi-dimensional load) to generate a biaxial stress state in the crystalline material, thereby enabling determination of Young's modulus and Poisson's ratio with respect to different axes of the crystalline material, for example, in sampling an anisotropic material.

As will be described in greater detail below, the system and method may be applicable to a variety of materials in a variety of applications. For example, in some embodiments, the method and system can provide a non-destructive approach to sample characterization, which, in certain applications, may be necessary to preserve the integrity of the tested samples. In other examples, the system may be transportable for field use on location, thereby facilitating the crystalline material characterization procedure. Also, the system and method may be applicable to different material types, for example by selecting appropriate surface acoustic wave devices for generating such waves in the crystalline material in question. For instance, in electrically conductive materials, an electromagnetic device such as an electromagnetic acoustic transducer (EMAT) can be used to generate these waves, whereas for a non-conductive material, alternate means for imparting material vibrations in the surface of the crystalline material can be used. In the former application, it will be appreciated that the use of an EMAT can enable generation of surface acoustic waves in materials of different sizes and shapes, for example, thin wires or other such materials having rounded or irregular surfaces otherwise difficult to process via standard means. These and other such approaches will be readily appreciated by the person of ordinary skill in the art upon reference to the following description of exemplary embodiments.

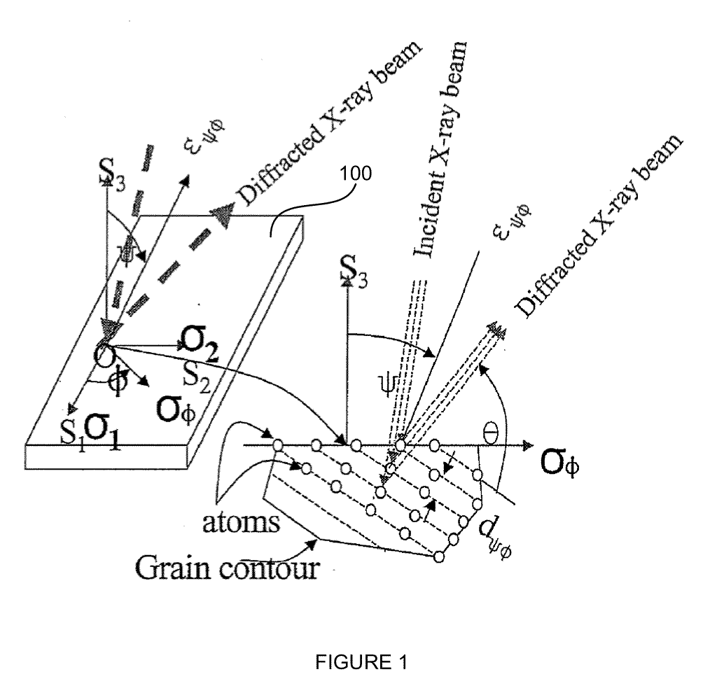

With reference to FIG. 1, general principles relating to x-ray diffraction and applicable in some embodiments of the invention will now be presented. In this figure, a sample plate 100 is provided for which are defined arbitrary sample axes S1 and S2 within a plane of this plate, and axis S3 perpendicular to this plane. Given this reference frame, a stress σ₁₀₀ generated by a load applied to the plate in a selected direction forming an angle φ relative to the S1 axis can be broken into respective components σ₁ and σ₂. An x-ray beam incident on the plate 100 at an angle ψ from the normal of the crystalline material's surface (i.e. relative to the cross product of S1 and S2) and projecting in the S3-φ plane, can be used to assess a strain ε_{ψφ} induced by the load, which is provided generally by a relative deformation of the crystalline structure of the crystalline material denoted by a relative change in the atomic spacing d_{ψφ} between the crystalline planes of the crystalline material in the ψ-direction. As will be known to the person of skill in the art, the atomic spacing d_{ψφ} can generally be measured from the Bragg equation:

nλ=2d_{ψφ sin θ} (1)

wherein n is an integer, λ is the wavelength of the x-ray beam and θ is the angle of incidence of the x-ray beam relative to the atomic planes in question.

Given this generic setup, Young's modulus E and Poisson's ratio v of the crystalline material can be expressed relative to load axis φ as a function of the strain measured via x-ray diffraction by the following equation:

$$\begin{matrix}\frac{{d}_{φψ} - d}{{d}_{0}} = \frac{1 + v}{E} {σ}_{φ} {sin}^{2} ψ - \frac{v}{E} ( {σ}_{1} + {σ}_{2} ) \\ wherein , & ( 2 ) \\ \frac{{d}_{φψ} - {d}_{0}}{{d}_{0}} = {ɛ}_{φψ} & ( 3 )\end{matrix}$$

and wherein ε_{φψ} denotes the directional strain measured in the horizontal φ-direction along the stress direction σ_{φ} and at the angle ψ from the normal σ₁×σ₂ to the crystalline material surface formed by the principal directions σ₁ and σ₂, d_{φψ} denotes the spacing between atomic planes in this direction, and d₀ denotes the original crystalline spacing in the absence of the applied load.

It will be appreciated by the person of ordinary skill in the art that applied stresses are additive and therefore, when dealing with a material wherein residual stress has been induced, for example, during manufacture of the crystalline material or sample at hand, such residual stress may be expressed in the above examples in a relatively straightforward manner. For example, and in accordance with one embodiment wherein the disclosed method and system are applied to a filamentary material, such as a metallic wire in the surface of which residual stress is relatively common, equation (2) can be expressed as follows (assuming an axial load and applied strain in the σ_{φ}=σ₁ direction):

$$\frac{{d}_{φψ} - d}{{d}_{0}} = \frac{1 + v}{E} ( {σ}_{1} + {σ}_{R} ) {sin}^{2} ψ - \frac{v}{E} ( {σ}_{1} + {σ}_{R} ) \qquad ( 4 )$$

wherein σ₁ and σ_{R} represent the applied and residual stresses respectively. Accordingly, upon repeating two or more strain measurements, a reasonably accurate determination of the residual stress may be achieved. This can then be used, as will be described further below, to improve an accuracy of the calculations relying on surface acoustic wave measurements. As will be appreciated by the person of ordinary skill in the art, other techniques to ascertain or at least approximate the residual stress in a material can also be considered herein without departing from the general scope and nature of the present disclosure. For example, following from the above scenario wherein the sampled material is comprised of a filamentary material, further x-ray measurements may be implemented at an extremity of the crystalline material to compare the atomic spacing of the crystalline material toward the surface and core of the crystalline material respectively.

As introduced above, measuring the propagation characteristics of surface acoustic waves in a material can provide a suitable approach for determining Young's modulus and Poisson's ratio. For instance, the propagation characteristics of such waves in a material can generally be expressed as a function of this material's elastic properties, such that a determination of these properties can be extracted provided sufficient data can be accumulated. For instance, in a simplified application where Poisson's ratio, for example, is well known or sufficiently well known, a determination of Young's modulus can be extracted directly from surface acoustic wave measurements alone. For example, provided the relationship between the propagation characteristics of surface acoustic waves and the crystalline material properties is known, and that one or more of the crystalline materials characteristics can be relatively well approximated, a relatively accurate determination of these properties can be extracted from surface acoustic wave measurements either from direct calculation, or through various iterative and/or data fitting algorithms and processes, which should be apparent to the person of skill in the art. However, when neither material characteristics are known, which is often the case when seeking to determine Young's modulus and Poisson's ration for a given sample, the embodiments of the invention herein described provide for a combined approach wherein x-ray diffraction strain measurements, as described above, can provide suitable results that, in combination with surface acoustic wave measurements described below, can lead to a relatively accurate determination of both Young's modulus and Poisson's ratio.

For example, in one such embodiment, Rayleigh waves are used, which are also at times referred to as Rayleigh-Lamb waves, Lamb waves or generalized Rayleigh waves when guided in layers, and which generally comprise surface waves that travel on a solid. As will be appreciated by the person of skill in the art, Rayleigh waves are distinct from other types of of acoustic waves such as longitudinal (P) and shear (S) waves that generally travel in the bulk of the crystalline material and are generally referred to herein as bulk waves.

As known in the art, surface acoustic waves, such as Rayleigh waves, can be generated by an acoustic transducer or the like. For example, in one embodiment, these waves are generated in an electrically conductive material using an electromagnetic acoustic transducer (EMAT). These and other such surface acoustic wave devices will be known to the person of ordinary skill in the art, and are therefore not meant to depart from the general scope and nature of the present disclosure.

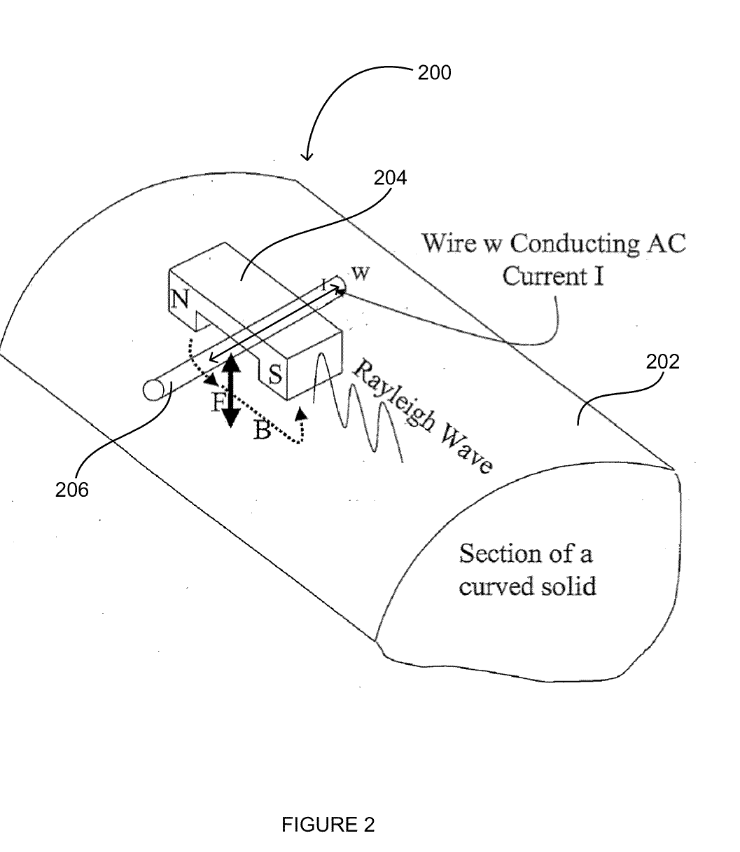

FIG. 2 provides, in accordance with one embodiment of the invention, a general representation of a device 200 for generating a surface acoustic wave, such as a Rayleigh wave or the like, in an electrically conductive solid material, in this example, a curved solid material 202 having a cylindrical or tubular structure. For instance, in FIG. 2, the device 200 is generally comprised of an electromagnetic acoustic transducer (EMAT) comprising a magnet 204, which induces a magnetic field B, disposed such that its north (N) and south (S) poles rest on either side of a wire 206 disposed substantially perpendicular to the magnet's N-S axis. In operation, the wire 206 is generally configured to conduct an alternative current I (e.g. provided by an AC power source, not shown), which induces a current J (not shown) in the surface of the crystalline material flowing in an opposite direction to current I. The action force F=J×B, identified by the double arrow F in this figure, can thus generally induce a vertical oscillation of the crystalline material's surface, which ultimately results in a surface acoustic wave propagating in that surface in both directions of the magnet, i.e. along the N-S axis thereof.

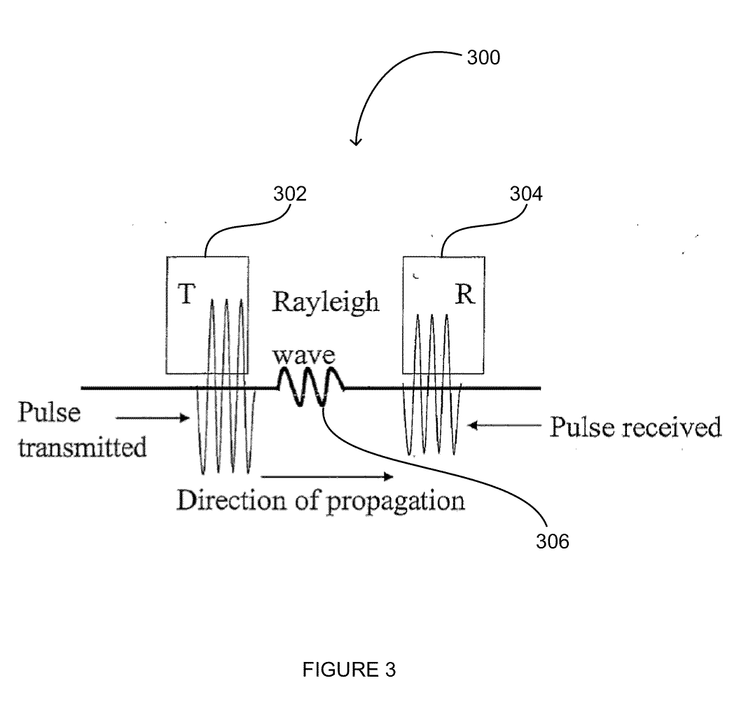

FIG. 3 provides a diagrammatic representation of a surface acoustic wave device 300 for transmitting and receiving one or more surface acoustic waves, such as Rayleigh waves, in accordance with one embodiment of the invention. In this embodiment, the device 300 is comprised of an electromagnetic acoustic transducer transmitter-receiver pair comprising a transmitter (T) 302 and receiver (R) 304. In general, the transmitter 302, such as described above in relation to FIG. 2, is configured to generate one or more surface acoustic waves in the crystalline material, depicted herein as a Rayleigh wave pulse 306, whereas the receiver 304 is configured to detect at least some of these waves, and in one embodiment, determine a transit time thereof within the crystalline material. From this transit time, a propagation velocity of the Rayleigh waves 306 in the medium can be determined. As will be appreciated by the person of ordinary skill in the art, velocity calculations may be based not only on direct transit times based on a known distance between the transmitter 302 and receiver 304, but also via indirect transit times calculated from waves reflected from one or more extremities, edges and/or other known interfering/reflecting elements (e.g. material defects, structures, etc.) of the sample or test subject provided distances are known between these elements and the transmitter/receiver. It will be further appreciated by the person of skill in the art that the surface acoustic wave device may comprise different levels and/or complexities of integrated circuitry and/or computation capacity, and therefore be configured to interface with one or more additional computing devices to enable calculation of the detected wave velocities. For example, in one embodiment, the surface acoustic wave device comprises a fully integrated device wherein velocity determinations are implemented automatically by the device for output to a display or to a downstream computing device for further processing. Alternatively, and in accordance with another embodiment, the surface acoustic wave device may comprise simple data acquisition functionalities wherein most or all computations and calculations are performed by one or more downstream computing devices configured to control activation of the transmitter and/or receiver. Other configurations and levels of automation will be readily apparent to the person of skill in the art and are therefore not intended to depart from the general scope and nature of the present disclosure.

As will be demonstrated below, by orienting the acoustic system 300 so to measure a velocity of a surface acoustic wave propagating in a selected direction of the crystalline material, the measured velocity, in combination with one or more strain measurements derived via x-ray diffraction with respect to this direction, Young's modulus and Poisson's ratio of the crystalline material can be determined relative to this direction.

For instance, in one embodiment, the following equation can be used, in combination with equation (2) above, to determine Young's modulus E and Poisson's ratio v of an electrically conductive crystalline material. Namely, the physical relationship between E and v relative to a given direction, and the propagation characteristics (i.e. propagation speed) of a Rayleigh wave propagating in a material in this direction can be provided by:

$$\frac{{c}_{R}^{2}}{{c}_{T}^{2}} [ \frac{{c}_{R}^{6}}{{c}_{T}^{6}} - 8 \frac{{c}_{R}^{4}}{{c}_{T}^{4}} + {c}_{R}^{2} ( \frac{24}{{c}_{T}^{2}} - \frac{16}{{c}_{L}^{2}} ) - 16 ( 1 - \frac{{c}_{T}^{2}}{{c}_{L}^{2}} ) ] = 0 \qquad ( 5 )$$

wherein c_{R} denotes the measurable speed of the Rayleigh wave in the medium, and c_{T} and c_{L} respectively denote the speed of transverse and longitudinal waves in the same material, which depend on E and v through the following relations:

$$\begin{matrix}{c}_{L}^{2} = \frac{E}{ρ} \frac{1 - v}{( 1 + v ) ( 1 - 2 v )} & ( 6 ) \\ {c}_{T}^{2} = \frac{E}{ρ} \frac{1 - v}{2 ( 1 + v )} & ( 7 )\end{matrix}$$

Accordingly, given that two equations can ultimately be provided for the same two unknowns E and v, these unknown characteristics can be extracted, and Δ denotes material's density.

As described above, and in accordance with one embodiment, residual stress that may be present in a tested material may affect surface acoustic wave measurements, and, if not properly accounted for, may adversely affect a determination of the crystalline material's elastic properties. Namely, it is known in the art that the velocity of a surface acoustic wave may be expressed by the following equation:

$${c}_{R} ( σ ) = {c}_{R} ( 0 ) + K σ \qquad ( 8 )$$

wherein σ is the total stress in the crystalline material's propagation surface, which may include both applied and residual stresses, K is an experimental constant and c_{R}(0) is the velocity in the absence of stress in the propagation surface. As will be appreciated by the person of ordinary skill in the art, upon conducting different velocity measurements for different applied stresses, a value for the constant K can be experimentally determined. However, without knowing how much residual stress is present in the crystalline material, a determination of c_{R}(0) may be difficult to achieve, which can then affect a determination of Young's modulus and Poisson's ratio which depend from this value as expressed by equations (5) to (7). However, as described above, if residual stress is suspected for a given material, or again, to verify to which extent residual stress may be present in a given material even when suspected to be negligible, x-ray diffraction measurements may first be used to assess this value, which can then be used to at least adjust surface acoustic wave measurements to improve an accuracy thereof.

In one exemplary embodiment, the above considerations are applied to a filamentary material, such as a metallic wire or the like, wherein the velocity and x-ray measurement are implemented along a longitudinal axis of this filamentary material such that Young's modulus and Poisson's ratio can be calculated with respect to this axis. In this embodiment, it will be appreciated that equation (2) can be simplified by expressing the stress generated by a load P applied in the longitudinal axis of the filamentary material by σ₂=0 and σ_{φ}=σ₁=σ=P/A, wherein A is the cross-section of the crystalline material in question.

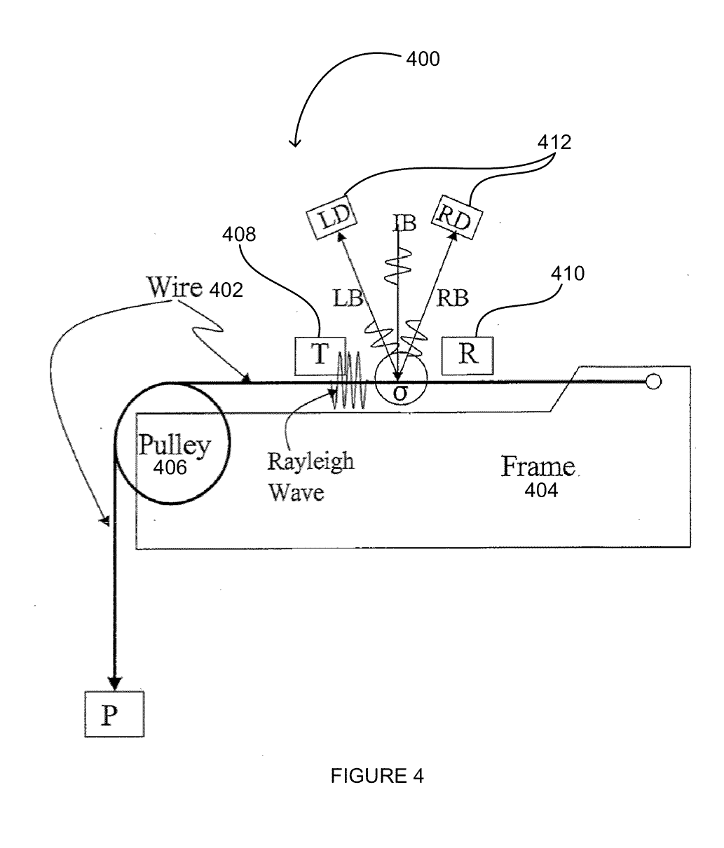

FIG. 4 provides an example of a system and apparatus 400 for implementing the above procedure on a filamentary material such as metallic wire 402. For example, the apparatus 400 comprises a frame 404 to which an end of the wire 402 is solidly anchored (e.g. removably anchored via one or more fastening means or devices that will be readily known to the person of ordinary skill in the art). A pulley 406 is also operatively mounted to the frame 404 so to enable application of a known gravitational load P on the opposite end of the wire 402 (e.g. via a weight or the like mounted or otherwise attached to this opposite end) when this end of the wire 402 is extended from its anchor and suspended over the pulley 406. A surface acoustic wave device comprising for example an EMAT transmitter (T) 408 and receiver (R) 410 operatively disposed about the wire 402, and an x-ray diffraction device (partially shown), configured to focus an incident beam (IB) on a point of the wire 402 and further comprising, in this embodiment, left (LD) and right (RD) x-ray detectors 412, are also provided. Accordingly, both acoustic and x-ray measurements can be executed in a same setup configuration which provides for the application of one or more loads to the sampled material without requiring that the installation be disturbed or altered. In one exemplary embodiment, the compact setup of the illustrated embodiment can allow for greater transportability and/or operability of the system, thereby, in some embodiments, facilitating implementation of this system in remote/field testing applications.

The apparatus 400 further generally comprises, or is configured for operative coupling to, one or more computing devices configured to operate the apparatus in order to acquire data representative of the measured acoustic wave characteristics (e.g. transit times) and x-ray diffractions (e.g. diffraction angle, etc.). In one embodiment, for example, the computing device(s) comprises one or more data storage devices or media and one or more processors operatively coupled thereto, wherein the data storage device(s) comprise stored therein statements and instructions for operating the apparatus 400, or components thereof, in accordance with one or more preset data sampling, acquisition and/or storing routines consistent with a given sample type, or again, applied generically. The storage device(s) may further comprise statements and instructions for automatically calculating, from the measured sample characteristics, Young's modulus and Poisson's ratio for the sample in question. It will be appreciated by the person of ordinary skill in the art that the apparatus 400, and cooperative computing device(s), may be adequately configured to perform sufficient tests and measurements to promote or ensure statistically significant and/or consistent results, be it via appropriate testing and/or calibration sequences, sampling sequences (e.g. multiple discrete and/or continuous x-ray diffraction angles, multiple wave transit measurements that may include direct and/or reflected wave transit times, etc.). For example, in one embodiment, the apparatus 400 is configured to oscillate about a localized angle of incidence for a number of data samples in order to improve the precision of the measured diffraction angle. For example, in one embodiment, the x-ray unit oscillates through 15 different angles within a range of ±3 degrees. High resolution detectors, which may for example include high density pixel counts, can also be used to improve/maximise precise and accurate readings.

In one embodiment, the apparatus 400 is configured to provide measurements for wires 402 having a diameter greater than about 1 millimetre. In another embodiment, the apparatus 400 can further be operated with wires 402 having a diameter greater than 0.7 millimetres. In yet another embodiment, the apparatus 400 is configured to operate with wires 402 having a diameter as low as 0.5 millimetres. In yet another embodiment, the apparatus 400 is configured for operation with wires 402 having a diameter less than 0.5 millimetres.

In order to achieve such measurements, in accordance with some embodiments of the invention, the x-ray diffractometer comprises an aperture through which the incident x-ray beam is provided to the sample. In one such embodiment, an aperture of about 10 thousandths of an inch is provided. In another embodiment, an aperture of about 7 thousandths of an inch is provided. It will be appreciated by the person of ordinary skill in the art that while smaller apertures may lead to more localized results, as appropriate and/or necessary for smaller samples, longer data acquisition times will generally be required to ensure sufficient data (i.e. statistically significant data) is acquired for a selected level of accuracy and precision in the ensuing results.

One exemplary application for which the above embodiments may be considered advantageous over known systems is in the determination of Young's modulus and Poisson's ratio for thin metallic wires. For example, a precise and accurate determination of Young's modulus and Poisson's ratio for a thin wire, for instance as used in string instruments or the like, can enable one to study the principles associated with this string's behaviour when driven, for example as played when mounted on a particular instrument or the like. In addition, given that the disclosed method and system does not generally require that the crystalline material be sized or prepared for testing, sensitive materials, for example antique strings or the like to follow from the above example, can be tested without perturbing or significantly altering the integrity of the sample.

Another exemplary application for which the above and similar embodiments may be particularly interesting is in field testing, wherein a material for testing cannot be extracted from its operative environment to be tested. One such example includes materials found on large scale transportation equipment, such as an airplane or submarine, wherein removal and transportation of the part to be tested is not readily applicable. Other examples may also include pipelines, bridges or other such large scale structural bodies where testing on the ground may be beneficial, if not necessary. As the equipment required to implement the disclosed method can readily be made transportable, and is generally unaffected by the sample materials shape and/or size, testing of the above and other such exemplary materials can, in accordance with some embodiments, be achieved more easily than with conventional methods.

Furthermore, it will be appreciated by the person of ordinary skill in the art that, as the disclosed method provides a substantially non-invasive and generally non-destructive approach, various materials for which a destructive approach would not be suitable or appropriate can be otherwise tested in accordance with the various embodiments of the invention herein described.

It will be appreciated by the person of ordinary skill in the art that the above and other similar examples are not meant to be limiting, and that numerous other applications, which may not be limited by their sample size, shape or mobility, can also be considered herein without departing from the general scope and nature of the present disclosure.

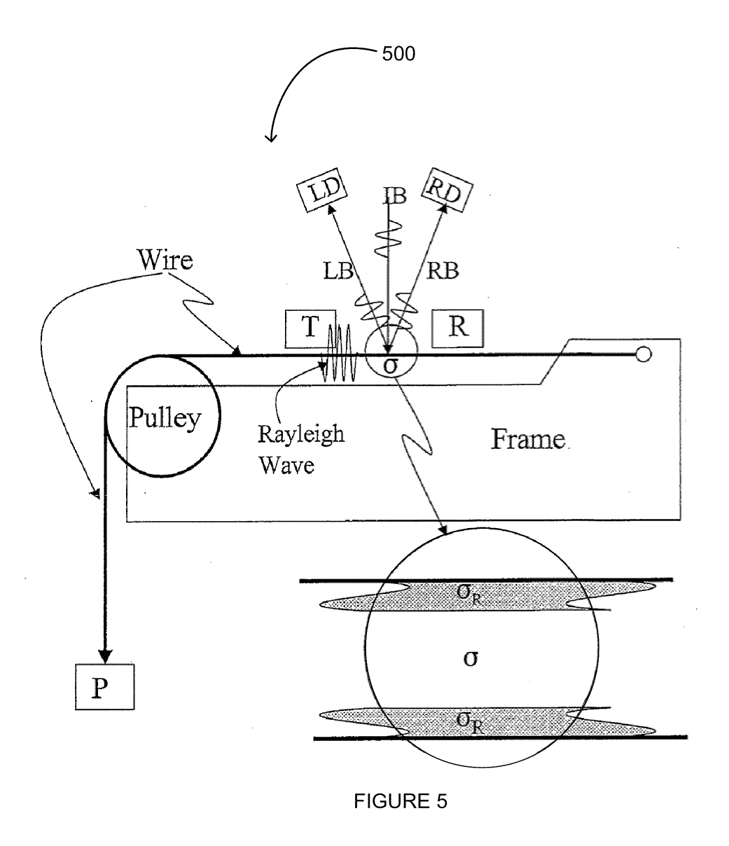

In one embodiment, and with reference to FIG. 5, a system and apparatus 500 is provided and used in a manner so as to account for residual stress in the sampled material. For instance, to follow from the above example, thin wires of diameter greater than about 0.75 mm generally exhibit some residual stress in a thin layer below their surface, which residual stress, as discussed above, can affect surface acoustic wave measurement. The apparatus 500 in this example, while similar to apparatus 400 described above with reference to FIG. 4, is operated so to enable an accounting for residual stress in the sampled material. For example, in the manufacture of a metallic wire or string, for example during swaging and/or drawing of such a wire, the crystalline material is disproportionately stretched or deformed on the surface relative to the core, thereby leading to distinct material characteristics in the crystalline material's surface. Similar residual stresses can also be detected in other manufactured materials depending on the process by which they are manufactured, material characteristics and resiliencies, and other such parameters readily known to the person of skill in the art.

In order to account for such residual effects, for instance in surface acoustic wave measurements that may be skewed by the presence of residual stress, and in accordance with one embodiment of the invention, the x-ray diffractometer of apparatus 500 can be operated for successive loads P, thereby allowing one to remove or at least substantially reduce the effect of residual stress, diagrammatically depicted herein as a region of stress σ_{R}, from a determination of Young's modulus and Poisson's ratio. Namely, as discussed above, the application of successive loads may allow for the effect of residual stress on calculated measurements to be substantially eliminated.

As will be appreciated by a person of ordinary skill in the art, the above examples provide methods for assessing Young's modulus and Poisson's ratio with respect to a single material axis. It will however be appreciated that for a substantially isotropic material, the above determinations can be applied, in most cases, for all material directions as a determination of Young's modulus and Poisson's ratio in respect of an arbitrary axis for an isotropic material generally applies substantially equally for all material axes.

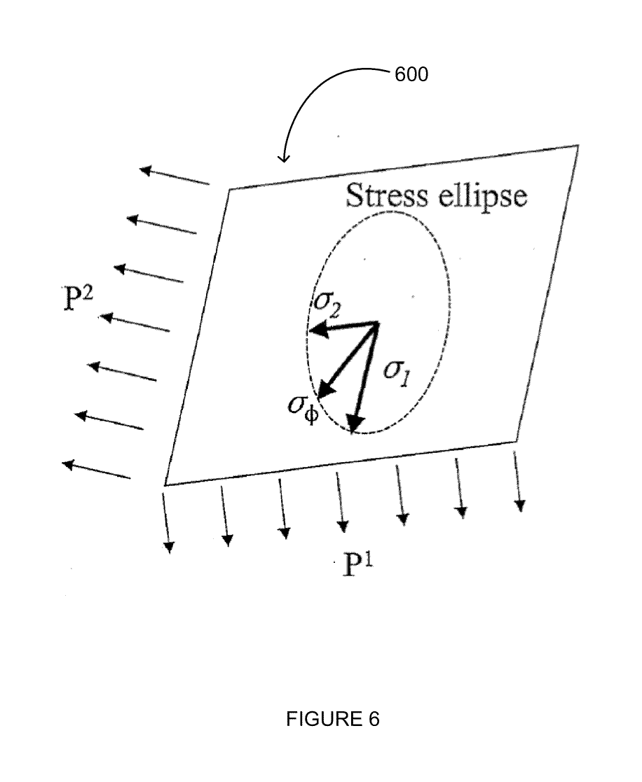

It will be appreciated, however, that the embodiments of the invention are not limited to isotropic materials as the systems and apparatuses described above can readily be adjusted to enable a determination of Young's modulus and Poisson's ratio with respect to different material axes when such respective parameters are not the same for all directions. For instance, it is generally known that for anisotropic materials, Young's modulus and Poisson's ratio with respect to two distinct material directions (which may but need not be orthogonal) are directionally dependent. For example, as depicted in FIG. 6 and in accordance with another embodiment of the invention, an anisotropic sheet material 600 is provided for testing, wherein distinct loads P¹ and P² can be applied in different directions along the crystalline material surface to produce a biaxial stress state expressed by the principal stress components σ₁ and σ₂, wherein the directional stress component σ_{φ} varies along the stress ellipse determined by these principal stress components. By implementing the above surface acoustic wave and x-ray diffraction measurements and calculations, but in this scenario, with respect to different axes, a determination of Young's modulus and Poisson's ratio with respect to two distinct directions (i.e. E₁, E₂, v₁ and v₂) can be achieved.

Once again, residual stress in the crystalline material can also be accounted for via sufficient x-ray diffraction measurements. Accordingly, to determine Young's modulus and Poisson's ratio in two distinct directions for an anisotropic material (i.e. E₁, E₂, v₁ and v₂) while accounting for residual stress in these directions, a sequence of surface acoustic wave and x-ray diffraction measurements are needed, which will be readily appreciated by the person of ordinary skill in the art.

It is apparent that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

We claim:

1. A method for determining a Young's modulus and a Poisson's ratio for a crystalline material, the method comprising the steps of:
generating one or more surface acoustic waves in the crystalline material and recording a velocity of the surface acoustic waves;
recording an applied strain in the crystalline material using X-ray diffraction; and
determining the Young's modulus and the Poisson's ratio of the crystalline material from the recorded velocity and applied strain.

2. The method of claim 1, wherein the applied strain is applied via a load applied along an axis of the crystalline material, and wherein the velocity and the applied strain are recorded with respect to the axis to determine Young's modulus and Poisson's ratio relative to the axis.

3. The method of claim 1, wherein the applied strain is applied via a multi-dimensional load applied along two or more axes of the crystalline material, and wherein the velocity and the applied strain are recorded with respect to each axis to determine the Young's modulus and the Poisson's ratio relative to each axis.

4. The method of claim 3, wherein the crystalline material is anisotropic.

5. The method of claim 1, wherein the method is non-destructive of the crystalline material.

6. The method of claim 2, wherein the crystalline material comprises a filamentary material, and the axis comprises a longitudinal axis of the filamentary material.

7. The method of claim 6, wherein a diameter of the filamentary material is less than about 1 mm.

8. The method of claim 7, wherein the diameter is less than about 0.5 mm.

9. The method of claim 1, wherein the recorded velocity and applied strain are recorded automatically in a data storage device responsive to the generation of the one or more surface acoustic waves and the X-ray diffraction, and wherein the determining step is implemented automatically by a computing device comprising a processor operatively coupled to the data storage device for output to a user thereof.

10. The method of claim 1, wherein the crystalline material is an electrically conductive material and wherein the one or more surface acoustic waves are generated via an electromagnetic acoustic transducer (EMAT).

11. The method of claim 1, wherein the generated one or more surface acoustic waves comprise one or more Rayleigh waves.

12. The method of claim 11, wherein the determining step is implemented by solving the following equations:
$$\begin{matrix}\frac{{c}_{R}^{2}}{{c}_{T}^{2}} [ \frac{{c}_{R}^{6}}{{c}_{T}^{6}} - 8 \frac{{c}_{R}^{4}}{{c}_{T}^{4}} + {c}_{R}^{2} ( \frac{24}{{c}_{T}^{2}} - \frac{16}{{c}_{L}^{2}} ) - 16 ( 1 - \frac{{c}_{T}^{2}}{{c}_{L}^{2}} ) ] = 0 \\ where {c}_{L}^{2} = \frac{E}{ρ} \frac{1 - v}{( 1 + v ) ( 1 - 2 v )} and {c}_{T}^{2} = \frac{E}{ρ} \frac{1 - v}{2 ( 1 + v )} ; and & ( 1 ) \\ \frac{{d}_{φψ} - d}{{d}_{0}} = \frac{1 + v}{E} {σ}_{φ} {sin}^{2} ψ - \frac{v}{E} ( {σ}_{1} + {σ}_{2} ) & ( 2 )\end{matrix}$$

13. The method of claim 12, wherein equation (2) is used to obtain a first relationship characterising the crystalline material and wherein equation (1) is then solved numerically by incorporating the first relationship therein.

14. The method of claim 1, further comprising the step of measuring a residual stress in the crystalline material using X-ray diffraction, and reducing an effect of the residual stress in determining the Young's modulus and the Poisson's ratio.

15. The method of claim 14, wherein the residual stress is measured by recording one or more additional applied strains in the crystalline material.

16. A system for determining a Young's modulus and a Poisson's ratio for a crystalline material, the system comprising:
a surface acoustic wave device for generating a surface acoustic wave in the crystalline material and recording a velocity of the surface acoustic wave;
a loading mechanism for applying a load to the crystalline material;
an X-ray diffractometer for recording an applied strain in the loaded crystalline material; and
a computing device comprising one or more data storage devices for storing the recorded velocity and applied strain, and one or more processors operatively coupled to the one or more data storage devices for calculating the Young's modulus and the Poisson's ratio of the crystalline material from the recorded velocity and applied strain.

17. The system of claim 16, wherein:
the loading mechanism is configured to apply the load along an axis of the crystalline material;
the surface acoustic wave device and the X-ray diffractometer are configured for recording the velocity and the applied strain with respect to the axis; and
wherein the computing device is configured to calculate Young's modulus and Poisson's ratio of the crystalline material relative to the axis.

18. The system of claim 16, wherein:
the loading mechanism is configured to apply a multi-dimensional load to the crystalline material;
the surface acoustic wave device and the X-ray diffractometer are configured for recording a corresponding surface acoustic wave velocity and applied strain for each of two or more axes; and
wherein the computing device is configured to determine the Young's modulus and the Poisson's ratio of the crystalline material relative to each of the axes from each the corresponding surface acoustic wave velocity and applied strain.

19. The system of claim 17, wherein the crystalline material comprises a filamentary material, and the axis comprises a longitudinal axis of the filamentary material.

20. The system of claim 19, wherein the loading mechanism comprises a support mechanism for supporting the filamentary material in a substantially horizontal orientation and one or more pulley mechanisms for applying a gravitational load on the horizontally oriented filamentary material.

21. The system of claim 16, wherein the X-ray diffractometer comprises an X-ray nozzle having an aperture of less than about 10 thousandths of an inch for enabling determination of the Young's modulus and the Poisson's ratio in thin materials.

22. The system of claim 21, wherein the aperture is about 7 thousandths of an inch.

23. The system of claim 16, wherein the X-ray diffractometer and the surface acoustic wave device are configured to enable a determination of Young's modulus and Poisson's ratio in filamentary materials having a diameter of less than about 1 mm.

24. The system of claim 16, wherein the system is transportable for use in a field environment.

25. The system of claim 16, wherein the surface acoustic wave device comprises an electromagnetic acoustic transducer (EMAT) for use with electrically conductive materials.
